(19) United States
(12) Patent Application Publication
(10) Pub. No.: US 2020/0103586 A1
(43) Pub. Date: Apr. 2, 2020

(54) DEVICE FOR FABRICATING OPTICAL FIBER BRAGG GRATING AND THE METHOD THEREOF

(71) Applicant: SHENZHEN UNIVERSITY, Shenzhen (CN)

(72) Inventors: Jun He, Shenzhen (CN); Zhe Zhang, Shenzhen (CN); Yiping Wang, Shenzhen (CN)

(21) Appl. No.: 16/699,116

(22) Filed: Nov. 29, 2019

Related U.S. Application Data
(63) Continuation of application No. PCT/CN2017/100996, filed on Sep. 8, 2017.

(51) Int. Cl. G02B 6/02; B23K 26/06; B23K 26/073; B23K 26/36; B23K 26/18

(52) U.S. Cl. CPC G02B 6/02138; B23K 26/0608; B23K 26/073; B23K 26/18; B23K 26/0626; B23K 26/36; B23K 26/0643

(57) ABSTRACT

Provided are a device and method for fabricating an optical fiber Bragg grating, comprising a laser device, a laser shaping device, a laser interference device, a clamping movable device, and an organic-solution filling device; a liquid filling port of the clamping movable device is connected to the output port of the organic-solution filling device; the laser device emits laser light to the laser shaping device; the laser shaping device shapes the laser light, then transmits it to the laser interference device; the laser interference device splits the laser into two laser beams; the two laser beams interfere and periodically distributed laser interference fringes are obtained; the organic-solution filling device fills and attaches the organic solution to the surface of the inner wall of an hollow-core fiber; the clamping movable device moves the hollow-core fiber.

### CROSS-REFERENCE TO RELATED APPLICATION

This application is a continuation of International Application No. PCT/CN2017/100996, filed on Sep. 8, 2017, the entire content of which is incorporated herein by reference.

### TECHNICAL FIELD

The present disclosure belongs to the technical field of fiber gratings, and in particular to a device for preparing optical fiber Bragg grating and the preparing method thereof.

### BACKGROUND

Optical fiber Bragg grating is a reflective fiber grating device and is widely applied to optical fiber communication and optical fiber sensing fields. In the prior art, a method for preparing optical fiber Bragg grating mainly comprises an ion beam etching method or an ultrafast laser processing method. The ion beam etching method and the ultrafast laser processing method theoretically can prepare the optical fiber Bragg grating by aiming at any fibers; however, a hollow-core optical fiber has a special air optical fiber core structure, so laser needs to be accurately focused in an inner wall of the hollow-core optical fiber when the optical fiber Bragg grating is directly written in the hollow-core optical fiber by utilizing the ion beam etching method or the ultrafast laser processing method, thereby improving the preparation complexity.

Therefore, the prior art has a technical problem that the laser needs to be accurately focused in the inner wall of the hollow-core optical fiber when the optical fiber Bragg grating is prepared by utilizing the ion beam etching method or the ultrafast laser processing method, thereby improving the preparation complexity.

### SUMMARY

The main objective of the present disclosure is to provide a device and method for manufacturing optical fiber Bragg grating in order to solve a technical problem that laser needs to be accurately focused in an inner wall of a hollow-core optical fiber when a optical fiber Bragg grating is prepared by utilizing an ion beam etching method or an ultrafast laser processing method, thereby improving the preparation complexity in the prior art.

To achieve the above objective, the present disclosure provides a device for preparing optical fiber Bragg grating, and the device comprises a laser device, a laser shaping device, a laser interference device, a clamping and moving device and organic solution filling device;

a liquid filling port of the clamping and moving device is connected with an output port of the organic solution filling device; and

the laser device emits a laser to the laser shaping device, the laser shaping device performs a shaping process on the laser and then emits the shaped laser to the laser interference device, the laser interference device divides the shaped laser into two laser beams and then interferes the two laser beams so as to obtain periodically distributed laser interference fringes, the organic solution filling device fills and attaches organic solution onto an inner wall surface of a hollow-core optical fiber, and the clamping and moving device moves the hollow-core optical fiber, the inner wall surface of which is filled and attached with the organic solution, to an area where the laser interference fringes are located and ensures that an air optical fiber core of the hollow-core optical fiber is located on a focal plane of the laser interference fringes.

Preferably, the organic solution filling device comprises a liquid storage chamber, a first filling conduit, a second filling conduit, a pressure pump and a vacuum absorber; and

one end of the liquid storage chamber is connected with the pressure pump while the other end thereof is connected with one end of the first filling conduit, the other end of the first filling conduit is connected with one end of the hollow-core optical fiber, the other end of the hollow-core optical fiber is connected with one end of the second filling conduit, and the other end of the second filling conduit is connected with the vacuum absorber.

Preferably, the liquid storage chamber stores an organic solvent.

Preferably, the organic solvent has a property of absorbing the laser.

Preferably, the organic solvent is toluene solution or pyrene-doped acetone solution.

Preferably, the laser interference device is an optical phase mask or a laser two-beam interference optical path.

Preferably, the laser two-beam interference optical path comprises a laser beam splitter and a pair of rotating mirrors;

and the laser beam splitter divides the laser into two laser beams, and each laser beam is emitted to one rotating mirror.

Preferably, the hollow-core optical fiber is a hollow-core photonic bandgap optical fiber, a Kagome-structure photonic crystal optical fiber, a hollow-core quartz tube or a hollow-core anti-resonant optical fiber.

In order to achieve the above objective, the present disclosure further provides a method for preparing optical fiber Bragg grating. The method is applicable to the device for preparing optical fiber Bragg grating according to the present application, and the method comprises:

the laser device is turned on and emits a laser to the laser shaping device at a first preset laser output power;

the laser shaping device performs a shaping process on the laser and then emits the shaped laser to the laser interference device;

the laser interference device divides the shaped laser into two laser beams and then interferes the two laser beams so as to obtain periodically distributed laser interference fringes;

the organic solution filling device fills and attaches organic solution onto an inner wall surface of a hollow-core optical fiber;

the clamping and moving device moves the hollow-core optical fiber, the inner wall surface of which is filled and attached with the organic solution, to an area where the laser interference fringes are located and ensures that an air optical fiber core of the hollow-core optical fiber is located on a focal plane of the laser interference fringes; and

the laser device performs laser interference exposure at a second preset laser output power and writes the optical fiber Bragg grating, wherein the second preset laser output power is greater than the first preset laser output power.

Preferably, the step that the organic solution filling device fills and attaches organic solution onto an inner wall surface of a hollow-core optical fiber comprises:

the pressure pump pumps the organic solution in the liquid storage chamber into the air optical fiber core of the hollow-core optical fiber through the first filling conduit; and

the vacuum absorber adsorbs out a preset volume of the organic solution in the air optical fiber core such that the residual organic solution is attached on the inner wall surface of the hollow-core optical fiber.

The present disclosure provides the device and method for preparing optical fiber Bragg grating. The device comprises the laser device, the laser shaping device, the laser interference device, the clamping and moving device and the organic solution filling device, the liquid filling port of the clamping and moving device is connected with the output port of the organic solution filling device, the laser device emits the laser to the laser shaping device, the laser shaping device performs the shaping process on the laser and then emits the shaped laser to the laser interference device, the laser interference device divides the shaped laser into two laser beams and then interferes the two laser beams so as to obtain the periodically distributed laser interference fringes, the organic solution filling device fills and attaches the organic solution onto the inner wall surface of the hollow-core optical fiber, and the clamping and moving device moves the hollow-core optical fiber, the inner wall surface of which is filled and attached with the organic solution, to the area where the laser interference fringes are located and ensures that the air optical fiber core of the hollow-core optical fiber is located on the focal plane of the laser interference fringes. Compared with the prior art, the present disclosure utilizes the organic solution filling device to fill and attach the organic solution onto the inner wall surface of the hollow-core optical fiber, then the hollow-core optical fiber, the inner wall surface of which is filled and attached with the organic solution, is moved to the area where the laser interference fringes are located, and the air fiber core of the hollow-core optical fiber is located on the focal plane of the laser interference fringes, so the optical fiber Bragg grating can be directly written, and the laser does not need to be accurately focused in the inner wall of the hollow-core optical fiber. Therefore, the optical fiber Bragg grating can be simpler and more convenient to be prepared.

### BRIEF DESCRIPTION OF THE DRAWINGS

FIG. 1 is a schematic structural diagram of a device for preparing optical fiber Bragg grating provided by the first embodiment of the present disclosure;

FIG. 2 is another schematic structural diagram of a device for preparing optical fiber Bragg grating provided by a first embodiment of the present disclosure;

FIG. 3 is a detailed schematic structural diagram of a device for preparing optical fiber Bragg grating provided by a first embodiment of the present disclosure; and

FIG. 4 is a flowchart of a method for preparing optical fiber Bragg grating provided by a second embodiment of the present disclosure.

### DESCRIPTION OF THE EMBODIMENTS

To make the foregoing objective, features, and advantages of the present disclosure clearer and more comprehensible, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of skill in the art based on the embodiments of the present disclosure without creative efforts shall fall within the protection scope of the present disclosure.

The following describes technical solutions of the present disclosure by means of specific embodiments.

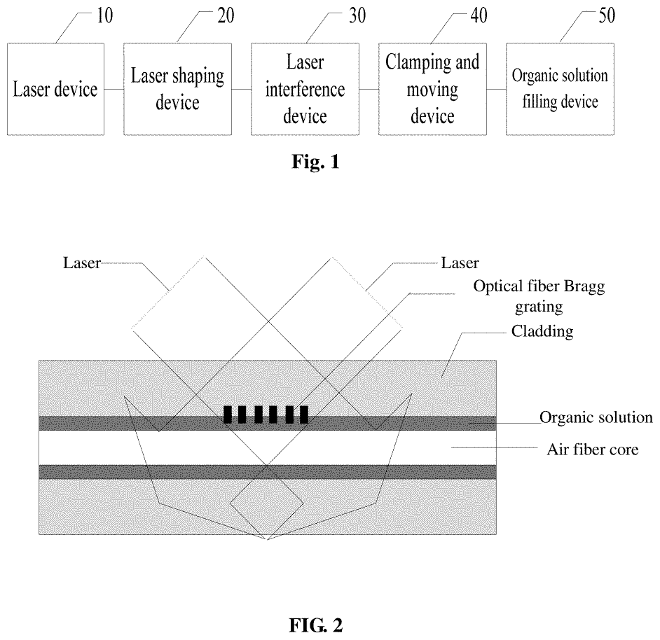

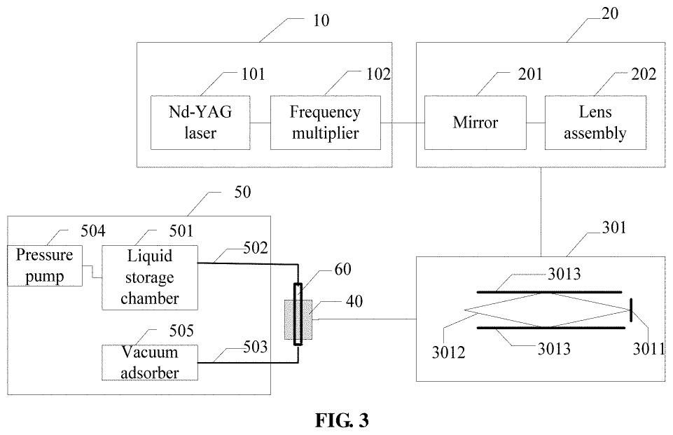

To better understand the present disclosure, referring to FIG. 1 which is a schematic structural diagram of a device for preparing optical fiber Bragg grating, FIG. 2 which is another schematic structural diagram of a device for preparing optical fiber Bragg grating, and FIG. 3 which is a detailed schematic structural diagram of a device for preparing optical fiber Bragg grating, the device comprises a laser device 10, a laser shaping device 20, a laser interference device 30, a clamping and moving device 40 and an organic solution filling device 50;

the clamping and moving device 40 has a liquid filling port, which is connected with an output port of the organic solution filling device 50; and

the laser device 10 emits a laser to the laser shaping device 20, the laser shaping device 20 performs a shaping process on the laser and then emits the shaped laser to the laser interference device 30, the laser interference device 30 divides the shaped laser into two laser beams and then interferes the two laser beams so as to obtain periodically distributed laser interference fringes, the organic solution filling device 50 fills and attaches an organic solution onto an inner wall surface of a hollow-core optical fiber 60, and the clamping and moving device 40 moves the hollow-core optical fiber 60, the inner wall surface of which is filled and attached with the organic solution, to an area where the laser interference fringes are located and ensures that an air optical fiber core of the hollow-core optical fiber 60 is located on a focal plane of the laser interference fringes.

In one embodiment of the present disclosure, as shown in FIG. 2, the hollow-core optical fiber 60 comprises a cladding and an air fiber core, and the organic solution is attached on the inner wall surface of the hollow-core optical fiber 60, the two laser beams interfere so as to obtain the periodically distributed laser interference fringes.

In one embodiment of the present disclosure, as shown in FIG. 3, the laser device 10 provides laser energy required by preparation of the optical fiber Bragg grating, and the laser device 10 consists of an Nd-YAG laser 101 and a frequency multiplier 102; the laser shaping device 20 consists of a preset number of mirrors 201 and a lens assembly 202 and can output laser beams according to a preset angle by adjusting the angle of each mirror 201, wherein the preset number of mirrors 201 can be provided according to actual situation, preferably two mirrors 201 are provided; and the position of each lens in the lens assembly 202 can be adjusted to change the laser focus so as to shape the laser; and the laser shaping module adjusts and controls energy distribution and emission direction of laser spots by shaping the laser.

In particular, the laser of the laser device 10 is a high-energy pulsed laser and can be a nanosecond pulsed laser, a sub nanosecond pulsed laser or a picosecond pulsed laser, and according to types, the laser may be an excimer laser, a gas laser, a solid laser, a semiconductor laser, a optical fiber laser and the like.

In particular, the wavelength of the laser outputted by the laser device 10 may be one of 193 nm, 213 nm, 248 nm, 266 nm, 313 nm, 355 nm and 532 nm.

Furthermore, the hollow-core optical fiber 60 is a hollow-core photonic band gap optical fiber, a Kagome-structure photonic crystal optical fiber, a hollow-core quartz tube or a hollow-core anti-resonant optical fiber.

Furthermore, the laser interference device 30 is an optical phase mask or a laser two-beam interference optical path 301.

As shown in FIG. 3, the laser two-beam interference optical path 301 comprises a laser beam splitter 3011 and a pair of rotating mirrors 3013;

the laser beam splitter 3011 divides the laser into two laser beams, and each laser beam is emitted to one rotating mirror 3013.

In another embodiment of the present disclosure, rotating mirrors 3013 are adjusted so as to obtain the periodically distributed laser interference fringes.

In particular the laser beam splitter 3011 can be a beam splitter prism_ or an optical phase mask.

In another yet embodiment of the present disclosure, different periods of optical fiber Bragg gratings can be designed according to requirements by utilizing the laser interference device 30.

Furthermore, the clamping and moving device 40 consists of a pair of optical fiber clamps, a pair of three-dimensional displacement platforms, a long-stroke electric displacement platform and an adapter plate.

In one embodiment of the present disclosure, the optical fiber clamps and the three-dimensional displacement platforms are adjusted to ensure that the hollow-core optical fiber 60 is vertical to an incidence direction of the laser, and the long-stroke electric displacement platform is adjusted to move in the incidence direction of the laser till the air optical fiber core of the hollow-core optical fiber 60 is located on the focal plane of the laser interference fringes.

In particular the morphology of diffracted lights behind the hollow-core optical fiber 60 can be observed to judge whether the hollow-core optical fiber 60 is located on the focal plane.

Furthermore, the organic solution filling device 50 comprises a liquid storage chamber 501, a first filling conduit 502, a second filling conduit 503, a pressure pump 504 and a vacuum absorber 505; and

one end of the liquid storage chamber 501 is connected with the pressure pump 504 while the other end thereof is connected with one end of the first filling conduit 502, the other end of the first filling conduit 502 is connected with one end of the hollow-core optical fiber 60, the other end of the hollow-core optical fiber 60 is connected with one end of the second filling conduit 503, and the other end of the second filling conduit 503 is connected with the vacuum absorber 505.

Furthermore, the liquid storage chamber 501 stores an organic solvent.

Furthermore, the organic solvent has a property of absorbing the laser.

In one embodiment of the present disclosure, two ends of the hollow-core optical fiber 60 are respectively in seal connection with one end of the first filling conduit 502 and one end of the second filling conduit 503, the pressure pump 504 is turned on to pressurize, the organic solution in the liquid storage chamber 501 flows out through the first filling conduit 502 under the action of the pressure pump 504 and enters the air optical fiber core of the hollow-core optical fiber 60, the vacuum absorber 505 is turned on to adsorb out a preset volume of organic solution in the air optical fiber core, the adsorbed organic solution flows back the vacuum absorber 505 through the second filling conduit 503, and due to the surface tension of the organic solution, the residual organic solution is attached on the inner wall surface of the hollow-core optical fiber 60.

In one embodiment of the present disclosure, the organic solution is attached on the inner wall surface of the hollow-core optical fiber 60, the organic solution has the property of absorbing the laser, and based on a laser absorption function of the organic solution attached on the inner wall surface of the hollow-core optical fiber 60, local heat is performed to impact an inner wall of the hollow-core optical fiber 60 to form grating scores. The preparation method is widely applied to various pulsed lasers.

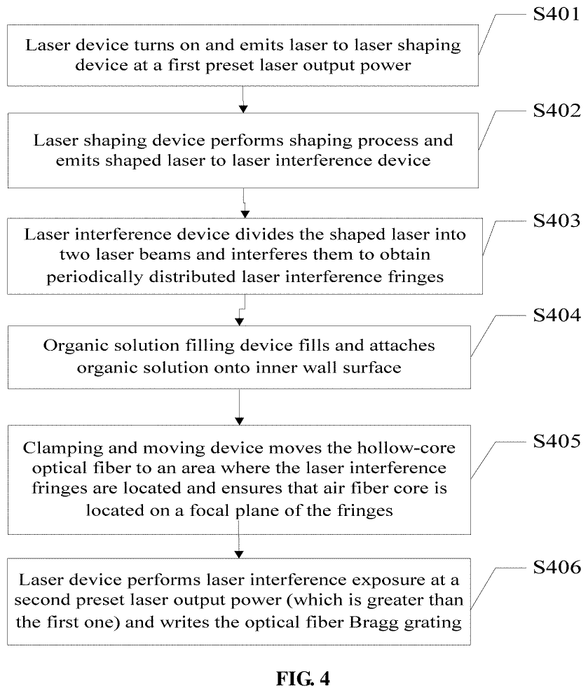

Referring to FIG. 4, FIG. 4 is a flowchart of a method for preparing optical fiber Bragg grating provided by a second embodiment of the present disclosure. The method comprises:

S401: the laser device 10 is turned on and emits a laser to the laser shaping device 20 at a first preset laser output power;

S402: the laser shaping device 20 performs a shaping process on the laser and then emits the shaped laser to the laser interference device 30;

S403: the laser interference device 30 divides the shaped laser into two laser beams and then interferes the two laser beams so as to obtain periodically distributed laser interference fringes;

S404: the organic solution filling device 50 fills and attaches organic solution onto an inner wall surface of a hollow-core optical fiber 60;

S405: the clamping and moving device 40 moves the hollow-core optical fiber 60, the inner wall surface of which is filled and attached with the organic solution, to an area where the laser interference fringes are located and ensures that an air optical fiber core of the hollow-core optical fiber 60 is located on a focal plane of the laser interference fringes; and

S406: the laser device 10 performs laser interference exposure at a second preset laser output power and writes the optical fiber Bragg grating, wherein the second preset laser output power is greater than the first preset laser output power.

In one embodiment of the present disclosure, the laser device 10 is turned on to be preheated, and when the output power of the laser is stable, the output power of the laser is reduced.

In particular the laser shaping module 20 comprises a plurality of mirrors 201 and a lens group 202, the mirrors 201 are adjusted to emit the laser according to a preset angle, and the lens group 202 is adjusted to adjust the focus to shape the laser.

In particular the laser interference device 30 is the optical phase mask or the laser two-beam interference optical path 301, the laser two-beam interference optical path 301 comprises a laser beam splitter 3011 and a pair of rotating mirrors 3013, and the rotating mirrors 3013 are adjusted so as to obtain the periodically distributed laser interference fringes, wherein the laser beam splitter 3011 can be a beam splitter prism or an optical phase mask.

In one embodiment of the present disclosure, different periods of optical fiber Bragg gratings can be designed according to requirements by utilizing the laser interference device 30.

In particular the second preset laser output power is greater than the first preset laser output power.

Furthermore, the step that the organic solution filling device 50 fills and attaches organic solution onto an inner wall surface of a hollow-core optical fiber 60 comprises:

the pressure pump pumps the organic solution in the liquid storage chamber into the air optical fiber core of the hollow-core optical fiber 60 through the first filling conduit; and

the vacuum absorber adsorbs out a preset volume of the organic solution in the air optical fiber core such that the residual organic solution is attached on the inner wall surface of the hollow-core optical fiber 60.

The organic solution filling device 50 comprises a liquid storage chamber 501, a first filling conduit 502, a second filling conduit 503, a pressure pump 504 and a vacuum absorber 505, one end of the liquid storage chamber 501 is connected with the pressure pump 504 while the other end thereof is connected with one end of the first filling conduit 502, the other end of the first filling conduit 502 is connected with one end of the hollow-core optical fiber 60, the other end of the hollow-core optical fiber 60 is connected with one end of the second filling conduit 503, the other end of the second filling conduit 503 is connected with the vacuum absorber 505, the liquid storage chamber 501 stores the organic solvent, the organic solvent has a property of absorbing the laser, and the organic solvent is toluene solution or pyrene-doped acetone solution.

In one embodiment of the present disclosure, two ends of the hollow-core optical fiber 60 are respectively in seal connection with one end of the first filling conduit 502 and one end of the second filling conduit 503, the pressure pump 504 is turned on to pressurize, the organic solution in the liquid storage chamber 501 flows out through the first filling conduit 502 under the action of the pressure pump 504 and enters the air optical fiber core of the hollow-core optical fiber 60, the vacuum absorber 505 is turned on to adsorb out a preset volume of organic solution in the air optical fiber core, the adsorbed organic solution flows back the vacuum absorber 505 through the second filling conduit 503, and due to the surface tension of the organic solution, the residual organic solution is attached on the inner wall surface of the hollow-core optical fiber 60.

In one embodiment of the present disclosure, the organic solution is attached on the inner wall surface of the hollow-core optical fiber 60, the organic solution has the property of absorbing the laser, and based on a laser absorption function of the organic solution attached on the inner wall surface of the hollow-core optical fiber 60, local heat is performed to impact an inner wall of the hollow-core optical fiber 60 to form grating scores. The preparation method is widely applied to various pulsed lasers.

In particular the clamping and moving device 40 consists of a pair of optical fiber clamps, a pair of three-dimensional displacement platforms, a long-stroke electric displacement platform and an adapter plate.

In one embodiment of the present disclosure, the optical fiber clamps and the three-dimensional displacement platforms are adjusted to ensure that the hollow-core optical fiber 60 is vertical to an incidence direction of the laser, and the long-stroke electric displacement platform is adjusted to move in the incidence direction of the laser till the air optical fiber core of the hollow-core optical fiber 60 is located on the focal plane of the laser interference fringes.

In particular the morphology of diffracted lights behind the hollow-core optical fiber 60 can be observed to judge whether the hollow-core optical fiber 60 is located on the focal plane.

In one embodiment of the present disclosure, the laser device 10 is turned on and emits a laser to the laser shaping device 20 at the first preset laser output power, the laser shaping device 20 performs a shaping process on the laser and then emits the shaped laser to the laser interference device 30, the laser interference device 30 divides the shaped laser into two laser beams and then interferes the two laser beams so as to obtain periodically distributed laser interference fringes, the organic solution filling device 50 fills and attaches an organic solution onto an inner wall surface of a hollow-core optical fiber 60, the clamping and moving device 40 moves the hollow-core optical fiber 60, the inner wall surface of which is filled and attached with the organic solution, to an area where the laser interference fringes are located and ensures that an air optical fiber core of the hollow-core optical fiber 60 is located on a focal plane of the laser interference fringes, and the laser device 10 performs laser interference exposure at a second preset laser output power and writes the optical fiber Bragg grating, wherein the second preset laser output power is greater than the first preset laser output power. Compared with the prior art, the present disclosure utilizes the device for preparing optical fiber Bragg grating, which is provided with the organic solution filling device 50; after the organic solution is filled and attached onto the inner wall surface of the hollow-core optical fiber 60, the hollow-core optical fiber 60, the inner wall surface of which is filled and attached with the organic solution, is moved to the area where the laser interference fringes are located, and the air optical fiber core of the hollow-core optical fiber 60 is located on the focal plane of the laser interference fringes, so the optical fiber Bragg grating can be directly written, and the laser does not need to be accurately focused in the inner wall of the hollow-core optical fiber 60. Therefore, the optical fiber Bragg grating can be simpler and more convenient to be prepared.

In some embodiments provided herein, it should be understood that the disclosed device and method may be implemented in other manners.

It should be noted that, for the sake of simplicity, the foregoing embodiments of the method are described as a series of action combinations, but those skilled in the art will recognize that the present disclosure is not limited by the sequence of actions described, certain steps may be carried out in another order or at the same time according to the present disclosure. Secondly, it should be understood by those skilled in the art that the embodiments described in the specification are preferred embodiments and the involved actions and modules are not necessarily necessary for the present disclosure.

In the above embodiments, the description of the embodiments each has a focus, and portions not described in detail in one embodiment may refer to the description of other embodiments.

The above describes the device and method for preparing optical fiber Bragg grating provided by the present disclosure. Those skilled in the art can make various modifications in terms of specific embodiments and scope of application in accordance with the teachings of the present disclosure. In conclusion, the content of this specification shall not be construed as a limitation to the present disclosure.

What is claimed is:

1. A device for preparing optical fiber Bragg grating, which comprises a laser device, a laser shaping device, a laser interference device, a clamping and moving device and organic solution filling device; wherein the clamping and moving device has a liquid filling port which is connected with an output port of the organic solution filling device; and
the laser device emits a laser to the laser shaping device, the laser shaping device performs a shaping process on the laser and emits a shaped laser to the laser interference device, the laser interference device divides the shaped laser into two laser beams and then interferes the two laser beams so as to obtain periodically distributed laser interference fringes, the organic solution filling device fills and attaches an organic solution onto an inner wall surface of a hollow-core optical fiber, and the clamping and moving device moves the hollow-core optical fiber with inner wall surface filled and attached with the organic solution to an area where the laser interference fringes are located and ensures that an air optical fiber core of the hollow-core optical fiber is located on a focal plane of the laser interference fringes.

2. The device of claim 1, wherein the organic solution filling device comprises a liquid storage chamber, a first filling conduit, a second filling conduit, a pressure pump and a vacuum absorber; and
the pressure pump is connected with one end of the liquid storage chamber while the other end of the liquid storage chamber is connected with one end of the first filling conduit, the other end of the first filling conduit is connected with one end of the hollow-core optical fiber, the other end of the hollow-core optical fiber is connected with one end of the second filling conduit, and the other end of the second filling conduit is connected with the vacuum absorber.

3. The device of claim 2, wherein the liquid storage chamber stores an organic solvent.

4. The device of claim 1, wherein the organic solvent has a property of absorbing the laser.

5. The device of claim 1, wherein the organic solvent is toluene solution or pyrene-doped acetone solution.

6. The device of claim 1, wherein the laser interference device is an optical phase mask or a laser two-beam interference optical path.

7. The device of claim 6, wherein the laser two-beam interference optical path comprises a laser beam splitter and a pair of rotating mirrors;
and
the laser beam splitter divides the laser into two laser beams, and each laser beam is emitted to one rotating mirror.

8. The device of claim 1, wherein the hollow-core optical fiber is a hollow-core photonic band gap optical fiber, a Kagome-structure photonic crystal optical fiber, a hollow-core quartz tube or a hollow-core anti-resonant optical fiber.

9. A method for preparing optical fiber Bragg grating, which is applicable to the device of claim 1, and the method comprises:
the laser device turns on and emits a laser to the laser shaping device at a first preset laser output power;
the laser shaping device performs a shaping process on the laser and emits a shaped laser to the laser interference device;
the laser interference device divides the shaped laser into two laser beams and then interferes the two laser beams so as to obtain periodically distributed laser interference fringes;
the organic solution filling device fills and attaches an organic solution onto an inner wall surface of a hollow-core optical fiber;
the clamping and moving device moves the hollow-core optical fiber with inner wall surface filled and attached with the organic solution to an area where the laser interference fringes are located and ensures that an air optical fiber core of the hollow-core optical fiber is located on a focal plane of the laser interference fringes; and
the laser device performs laser interference exposure at a second preset laser output power and writes the optical fiber Bragg grating, wherein the second preset laser output power is greater than the first preset laser output power.

10. The method of claim 9, wherein the organic solution filling device fills and attaches organic solution onto an inner wall surface of a hollow-core optical fiber comprises:
the pressure pump pumps the organic solution in the liquid storage chamber into the air optical fiber core of the hollow-core optical fiber through the first filling conduit; and
the vacuum absorber adsorbs out a preset volume of the organic solution in the air optical fiber core such that the residual organic solution is attached on the inner wall surface of the hollow-core optical fiber.
